(19) United States
(12) Patent Application Publication
(10) Pub. No.: US 2022/0382353 A1
(43) Pub. Date: Dec. 1, 2022

(54) POWER LIMITS BASED ON PROCESSOR THROTTLING

(71) Applicant: HEWLETT-PACKARD DEVELOPMENT COMPANY, L.P., Spring, TX (US)

(72) Inventors: Robert Cleveland BROOKS, JR., Spring, TX (US); Adam Mir ALI, Spring, TX (US)

(21) Appl. No.: 17/334,296

(22) Filed: May 28, 2021

(51) Int. Cl. G06F 1/3206; G06F 1/3287

(52) U.S. Cl. CPC G06F 1/3206; G06F 1/3287

(57) ABSTRACT

An example non-transitory machine-readable medium includes instructions that, when executed by a controller, cause the controller to detect an emergency throttling event of a central processing unit (CPU) of a computing device, and, if the CPU has undergone fewer than a threshold number of emergency throttling events, increase a current maximum power limit of the CPU to an increased maximum power limit.

### BACKGROUND

A computing device includes a processor, which may be referred to as a central processing unit (CPU), to perform computations and data manipulations that implement the processing functionality of the computing device. A CPU's processing throughput may be linked to the electrical power provided to the CPU.

### BRIEF DESCRIPTION OF THE DRAWINGS

FIG. 1 is a block diagram of an example non-transitory machine-readable medium with instructions that set a maximum power limit of a CPU based on emergency throttling events of the CPU.

FIG. 2 is a flowchart of an example method of setting a maximum power limit of a CPU based on emergency throttling events of the CPU.

FIG. 3 is a block diagram of an example computing device that sets a maximum power limit of a CPU based on emergency throttling events of the CPU.

FIG. 4 is a flowchart of an example method of setting a maximum power limit of a CPU based on emergency throttling events of the CPU, as constrained by a computing device's power supply and usage.

FIG. 5 is a flowchart of an example method to count emergency throttling events of a CPU.

FIG. 6 is a graph of power vs. time of a CPU with an example of setting of a maximum power limit of a CPU based on emergency throttling events of the CPU.

### DETAILED DESCRIPTION

A power limit of a CPU of a computing device may be set to a static value to prevent the CPU from drawing too much power. A static power limit for the CPU may be set by the computing device's Basic Input/Output System (BIOS) during a Power-On Self-Test (POST) sequence. A static power limit may be selected with regard to the other components of the computing device and their expected power draws and the power supply's capacity.

A static power limit may unduly limit the CPU's processing throughput at times when the computing device has available power capacity. For example, when other power-consuming components of the computing device, such as a Universal Serial Bus (USB) peripheral device, discrete graphics unit, memory/storage device, network interface controller (MC), etc., are using a low amount of power, the power supply may be able to provide additional power to the CPU. However, the CPU may be prevented from drawing such additional power due to its static power limit.

A static power limit may also cause undesirable side effects in the operation of the computing device. For example, during a power spike, such as when a user connects a power-drawing peripheral device to the computing device or causes an application to command various power-drawing components to operate, the CPU may undergo emergency throttling to quickly reduce its power draw. This may help reduce the impact of the power spike on the power supply and may prevent the power supply from shutting down due to overload. Repeated instances of emergency throttling of the CPU may cause power fluctuations that manifest as vibrations and/or noise due to, for example, the rapid charging and discharging of capacitors. Hence, power spikes may cause capacitors, such as the high-frequency capacitors located near the CPU, to “sing,” which is not desirable.

In addition, repeated instances of emergency throttling of the CPU may cause a reduction in processing throughput, as compared to using a lower CPU power limit that does not result in the same degree of emergency throttling. That is, overall processing efficiency may be reduced if the CPU undergoes emergency throttling at a high rate.

To increase processing throughput and reduce or eliminate undesirable side effects of power fluctuations, the CPU's power limit may be set dynamically during operation of the computing device according to power available. As emergency throttling is used to quickly reduce CPU power, instances of emergency throttling may be considered when determining whether the CPU's power limit may be increased or decreased. A high amount of recent emergency throttling indicates that CPU's power limit should remain the same or be lowered, so as to increase overall efficiency and reduce side effects such as capacitor singing. A low amount or no amount of recent emergency throttling indicates that CPU's power limit may be increased to increase processing throughput.

The power limit may be set at a level that is based on the number of recent emergency throttling events (e.g., PROCHOT# assertions) as well as power used by the CPU and other components of the computing device. A large number of recent emergency throttling events means that the power limit may be reduced quickly. A small number of recent emergency throttling events means that the power limit may be reduced slowly. A still fewer number of recent emergency throttling events (e.g., zero) means that the power limit may be increased. Changes in processor power limit, particularly increases, may be constrained by power usage of the remainder of the computing device, so as to avoid drawing too much power and potentially overloading the power supply unit and causing it to shut down.

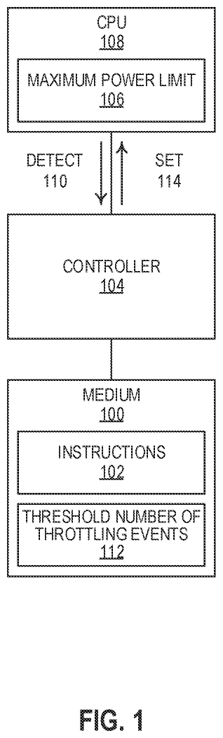

FIG. 1 shows an example non-transitory machine-readable medium 100 with instructions 102 that are executable by a controller 104 to set a maximum power limit 106 of a CPU 108 based on emergency throttling events experienced by the CPU 108.

The CPU 108 may be the main processor a computing device, such as a desktop computer, notebook computer, all-in-one (AiO) computer, or server. The CPU 108 may be the only CPU provided to the computing device or may be one of several CPUs provided. The maximum power limit 106 may be enforced by the CPU 108 and may be the maximum power draw that the CPU 108 is designed to never exceed, even temporarily. The CPU 108 may preemptively limit its operating frequency to prevent spikes above the maximum power limit 106. In some CPUs 108, such as those made by Intel™, the maximum power limit 106 may be referred to as Power Limit 4 or PL4. The CPU 108 may have a frequency control algorithm, e.g., Intel's Turbo, that controls the CPU's operating frequency with regard to the maximum power limit 106.

As will be discussed below, the maximum power limit 106 may be dynamically set to increase processing throughput when possible and to prevent the CPU 108 from drawing too much power and starving other components of the computing device and/or triggering an emergency shutdown of the computing device's power supply.

The non-transitory machine-readable medium 100 may include an electronic, magnetic, optical, or other physical storage device that encodes the instructions 102 that implement the functionality discussed herein. The machine-readable medium 100 may include non-volatile memory, such as read-only memory (ROM), electrically-erasable programmable read-only memory (EEPROM), or flash memory that cooperates with the controller 104 to execute the instructions 102.

The controller 104 is in communication with the CPU 108 and may be electrically connected to the CPU 108 by a bus or by conductive traces of a circuit board that carries the controller 104 and CPU 108. The controller 104 may be an embedded controller (EC), a super input/output (S10) integrated circuit, a microcontroller, a microprocessor, a field-programmable gate array (FPGA), an application-specific integrated circuit (ASIC), or a similar device capable of executing instructions. The controller 104 may include or have access to volatile working memory, such as a set of registers, random-access memory (RAM), or similar. In this example, the controller 104 is separate and distinct chip from the CPU 108. In other examples, the controller 104 may be provided on the same chip as the CPU 108, may be a subcomponent of the CPU 108, or may be integrated within the CPU 108.

In various examples, the controller 104 implements the functionality of an SIO chip and an EC, and implements power management functionality including the functionality discussed herein.

The instructions 102 may be directly executed, such as binary or machine code, and/or may include interpretable code, bytecode, source code, or similar instructions that may undergo additional processing to be executed. All of such examples may be considered executable instructions.

The instructions 102 detect 110 an emergency throttling event of the CPU 108. This may be achieved various ways.

In some examples, an emergency throttling signal is asserted to the CPU 108 by another device, such as an SIO integrated circuit, that manages power in the computing device. The CPU 108 receives the signal and initiates emergency throttling in response. The signal may be a PROCHOT# signal. Note that, although PROCHOT# means “processor hot,” this signal may be used to quickly reduce the CPU's power draw for any reason, thermal or otherwise. In these examples, the controller 104 may be connected to a pin of the CPU package where the signal is asserted to the CPU 108, such that an assertion to the CPU is detectable by the controller 104. The controller 104 may monitor the pin to determine whether the CPU 108 is undergoing emergency throttling. Each assertion of the emergency throttling signal may be considered to signify an emergency throttling event.

In other examples, the emergency throttling signal is asserted to the CPU 108 by the controller 104. In such case, the signal may be internal to the controller 104 and asserted to the CPU 108 via a pin on the CPU package.

In still other examples, the CPU 108 may assert a signal that indicates the degree of emergency throttling being performed, and such a signal may be further processed, for example, by the controller 104 to determine whether or not such a degree of emergency throttling qualifies as an emergency throttling event.

The instructions 102 may keep count of the number of emergency throttling events over time. If the CPU 108 is not undergoing significant emergency throttling, then the CPU's maximum power limit 106 may be increased, so as to increase performance. That is, few emergency throttling events indicate that the maximum power limit 106 may be increased. Conversely, a large number of emergency throttling events may indicate that the maximum power limit should be decreased. As such, the CPU's maximum power limit 106 may be controlled dynamically based on the controller's monitoring of CPU emergency throttling, so as to increase CPU throughput, increase efficiency by avoiding needless emergency throttling, and reduce the likelihood of unwanted side effects.

The instructions 102 may increase a current maximum power limit 106 of the CPU 108 to an increased maximum power limit if the CPU 108 has undergone fewer than a threshold number of emergency throttling events 112. This may allow the CPU 108 to increase its operational frequency, so as to increase processing throughput.

Likewise, the instructions 102 may decrease the current maximum power limit 106 of the CPU 108 to a decreased maximum power limit if the CPU 108 has undergone more than the threshold number of emergency throttling events 112 within the recency interval. This may reduce the number of future emergency throttling events in the CPU 108. Accordingly, the CPU 108 may operate with greater stability, as opposed to cycling between normal operation and emergency throttling, which can have side effects, such as causing power supply capacitors to vibrate or hum.

The instructions 102 may compare the count of emergency throttling events to the threshold number 112 and set 114 the maximum power limit 106 accordingly. The maximum power limit 106 may be set to a value that is constrained by the maximum allowed instantaneous power of the computing device that contains the CPU 108 with regard to the instantaneous power used by other components of the computing device besides the CPU 108, such as a USB peripheral device, graphics card or graphics processing unit (GPU), storage drive, memory device, NIC, and similar. That is, a power supply of the computing device may have a maximum allowed instantaneous power that it is capable of delivering. A demand that exceeds the maximum allowed instantaneous power may trigger the power supply to initiate an emergency shutdown. In addition, other components of the computing device are provided power by the same power supply. Hence, the instructions 102 may constrain the maximum power limit 106 of the CPU 108 based on the available power, namely, the maximum allowed instantaneous power of the computing device as reduced by power usage of the other components of the computing device. For example, the maximum power limit 106 may be set to:

(CPM_HLIM-ROP)*F

where CPM_HLIM is the maximum allowed instantaneous power of the computing device as a whole, as limited by the power supply,

ROP is the power used by the rest of the platform, that is, the components of the computing device other than the CPU 108, and

F is a factor, such as 0.90 or 0.95, to allow for a safety margin, which may be selected or tuned for specific implementations.

The threshold number of emergency throttling events 112 may be a configurable constant and may be tuned for specific implementations. Examples of threshold amounts are 0, 1, 5, 10, and 20. In the example of the threshold number 112 being zero, this means that the maximum power limit 106 is only increased if no recent emergency throttling event is detected. Detection of any recent emergency throttling event results in a decrease to the maximum power limit 106.

The threshold number 112 may be different for increasing and decreasing the maximum power limit 106. That is, when determining whether to increase the maximum power limit 106, the instructions 102 may compare the number of recent emergency throttling events to a first threshold. When determining whether to decrease the maximum power limit 106, the instructions 102 may compare the number of recent emergency throttling events to a second threshold. The first and second thresholds may be independently configurable and may be set to different values.

The instructions 102 may count emergency throttling events that occur during a recency interval and compare the count to the threshold number 112, so that older emergency throttling events do not affect the decision of whether or not to change the maximum power limit 106 of the CPU 108. The recency interval may be a recent time window, such as an interval selected from the range of about 50 milliseconds (his) to about 500 ms, for example, 200 ms. The recency interval may be a configurable constant and may be tuned for specific implementations.

The maximum power limit 106 may be set to a value, as discussed above. Such a value may depend on the power of the computing device that is available for the CPU and may be configurable and tunable, for example, by way of a factor. In various examples, that maximum power limit 106 may be set to a value that, as above, takes into account the power available for the CPU and, further, is inversely proportional to an amount of emergency throttling performed by the CPU. For example, a decrease of the maximum power limit 106 may be selected to be large when the number of recent emergency throttling events is high, whereas the decrease may be selected to be smaller when the number of recent emergency throttling events is not as high. As such, the instructions 102 may respond quickly to a sudden large increase in emergency throttling events. Likewise, if the number of recent emergency throttling events drops sharply, the instructions 102 may respond with a proportional increase to the maximum power limit 106.

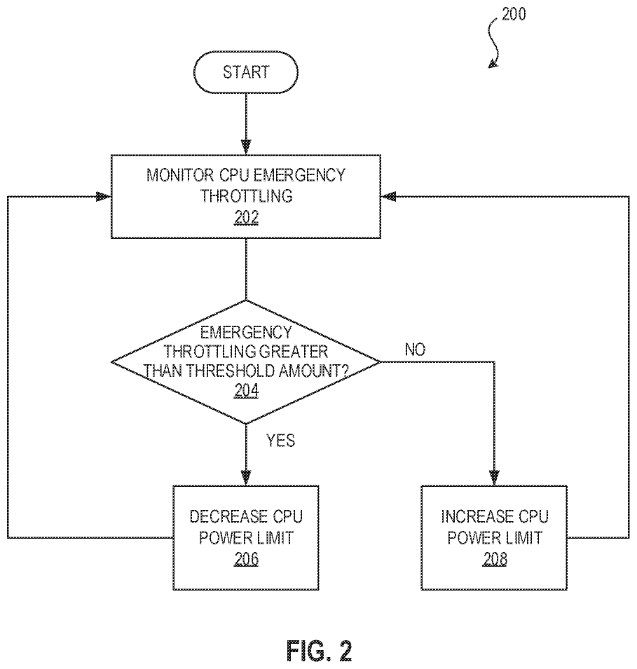

FIG. 2 shows an example method 200 of setting a maximum power limit of a CPU based on emergency throttling events of the CPU, The method 200 may be implemented as instructions that may be executed by a controller or similar device, as discussed elsewhere herein.

At block 202, emergency throttling of a CPU is monitored. This may be performed by a controller that is electrically connected to a pin of the CPU package that has a signal (e.g., PROCHOT#) indicating that emergency throttling is occurring. Such a signal may be asserted by a component outside the CPU, such as an 510 chip, an embedded controller , or a device that combines the functionality of an SIO chip and embedded controller. Monitoring emergency throttling may include tracking a count of recent emergency throttling events. For example, a simple count is maintained and is reset at regular intervals. In other examples, timestamped indications of emergency throttling events may be stored as emergency throttling events occur, and block 202 may include referencing the timestamps to count how many emergency throttling events exist within a recent time period.

At block 204, it is determined whether the recent emergency throttling exceeds a threshold amount. This may be done by comparing a count of recent emergency throttling events to a threshold number. If the emergency throttling is greater than the threshold amount, then emergency throttling is determined to be excessive and a power limit of the CPU may be decreased. If the emergency throttling less than or equal to the threshold, then emergency throttling is determined to be acceptable for an increase in the power limit of the CPU. In some examples, a threshold count of zero is used, so that detection of any number of recent emergency throttling event contravenes the threshold and prevents an increase to the power limit of the CPU. In such examples, only a lack of recent emergency throttling events allows increase to the CPU power limit.

At block 206, it is determined that the amount of recent emergency throttling is more than the threshold amount and, thus, the power limit of the CPU may be decreased. The amount by which to decrease the power limit of the CPU may be determined based on the amount of recent emergency throttling, such that a larger amount of recent emergency throttling results in a greater reduction of the CPU power limit.

At block 208, it is determined that the amount of emergency throttling is not more than the threshold amount and, thus, the power limit of the CPU may be increased. The amount by which to increase the power limit of the CPU may be determined based on power consumption by other components of the computing device and a total instantaneous power that can be provided by the computing device's power supply, so that the power limit of the CPU is not increased so much as to cause excessive power draw at the power supply.

The method 200 may be repeated continuously at a suitable frequency, so that the CPU power limit is adjusted dynamically in response to the amount of recent emergency throttling of the CPU.

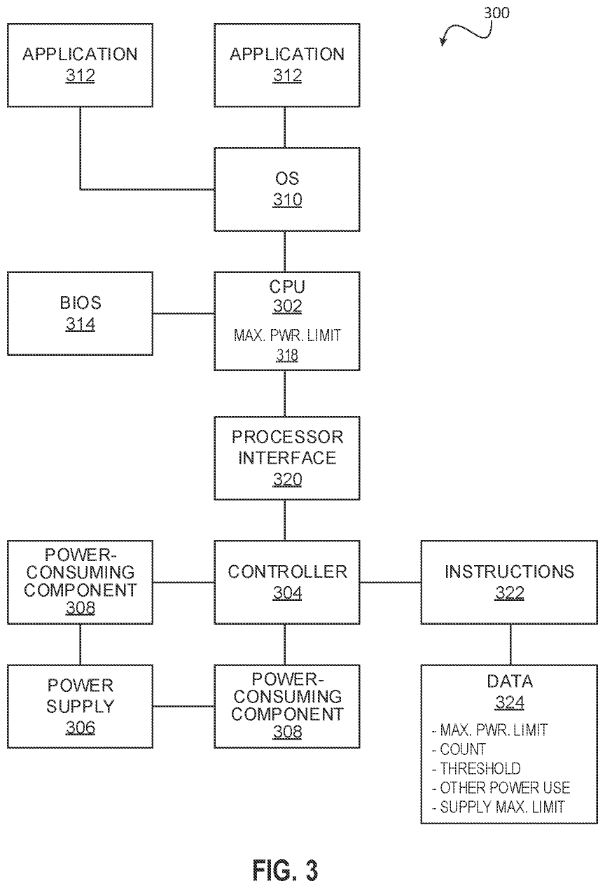

FIG. 3 shows an example computing device 300 that sets a maximum power limit of a processor or CPU 302 based on emergency throttling events of the CPU 302. The computing device 300 may be a desktop computer, notebook computer, AiO computer, server, or similar device. In addition to the components discussed below, the computing device 300 may include other components that are omitted for sake of brevity.

The computing device 300 includes the CPU 302, a controller 304, a power supply 306, and various power-consuming components 308, such as a USB peripheral device, graphics card, storage drive, and similar devices as discussed elsewhere herein.

The CPU 302 may execute an operating system (OS) 310, applications 312, and a BIOS 314.

The controller 304 may include an EC, 510 circuit, or similar device, as discussed above. The controller 304 may provide basic functions to the computing device 300, such as monitoring temperature, monitoring/controller power distribution, monitoring fan speed, capturing keyboard input, and similar.

The controller 304 may be connected to the CPU 302 and the other power-consuming components 308 to monitor power usage by the CPU 302 and other components 308. The controller 304 may further be connected to the CPU 302 to write and/or read a signal at the CPU 302 that indicates that the CPU 302 is undergoing emergency throttling. The controller 304 may be connected to a pin of the CPU package where such a signal (e.g., PROCHOT#) is available, whether asserted by the controller 304, the CPU 302, or by another component. In some examples, the controller 304 may assert the signal to the CPU 302 and thus the controller 304 may be aware of the signal without needing to monitor the pin. However, the controller 304 may still monitor the pin to confirm that the signal reached the CPU 302. An emergency throttling signal, such as PROCHOT#, may be bidirectional and the monitoring of such signal should consider this.

The controller 304 may store an indication of a maximum allowed instantaneous power deliverable by the power supply 306. The controller 304 may be connected to power supply 306 to obtain this information and/or monitor instantaneous power delivered by the power supply 306.

The power supply 306 may include a transformer, rectifier, voltage regulator, and/or similar components to convert wall/main power, such as 110 VAC at 60 Hz, to power usable by the computing device 300, such as 19, 5, or 3.3 VDC. The power supply may be referred to as a power support unit (PSU) and may be internal or external to the computing device 300 or may include components that are internal and external to the computing device 300.

The computing device 300 may further include a processor interface 320. The CPU 302 may have functionality that is accessible through the processor interface 320. Such functionality may include setting a maximum power limit 318 of the CPU 302 during operation of the computing device 300, i.e., while the computing device 300 is powered and performing tasks, such as running the application 312. The processor interface 320 may enforce a security protocol that requires authentication/authorization to enable, disable, or modify certain functions of the processor.

The computing device 300 further includes instructions 322 executable by the controller 304. The instructions 322 perform monitoring of emergency throttling at the CPU 302 and set the maximum power limit 318 of the CPU 302 according to the monitoring of the emergency throttling.

The instructions 322 may read/write data 324 that is maintained in volatile or non-volatile memory, such as internal memory of the controller 304, to set the maximum power limit 318 of the CPU 302. The data 324 may include a current maximum power limit of the CPU 302, a current count of recent throttling events, a threshold number of throttling events, current power usage levels of the power-consuming components 308, a maximum allowed instantaneous power deliverable by the power supply 306, and/or other information discussed elsewhere herein that may be used to compute an increased or decreased maximum power limit of the CPU 302.

The instructions 322 may increase the maximum power limit 318 of the CPU 302 in response to a low amount of recent emergency throttling. Conversely, the instructions 322 may decrease the maximum power limit 318 of the CPU 302 in response to a high amount of recent emergency throttling

The instructions 322 may further determine the power usage of the other components 308 and, when selecting a new maximum power limit 318 of the CPU 302, constrain the total of the maximum power limit 318 and the power usage of the other components 308 to not exceed the maximum allowed instantaneous power deliverable by the power supply 306. When increasing the maximum power limit 318, the instructions 322 may select an increased level for the maximum power limit 318 that has an inversely proportional relationship to the power usage of the other components 308. The smaller the power usage of the other components 308, the greater the permitted increase to the maximum power limit 318 of the CPU 302. Likewise, the greater the power usage of the other components 308, the smaller the permitted increase to the maximum power limit 318. Moreover, the instructions 322 may determine that the power usage of the other components 308 is so high as to prohibit any increase of the maximum power limit 318.

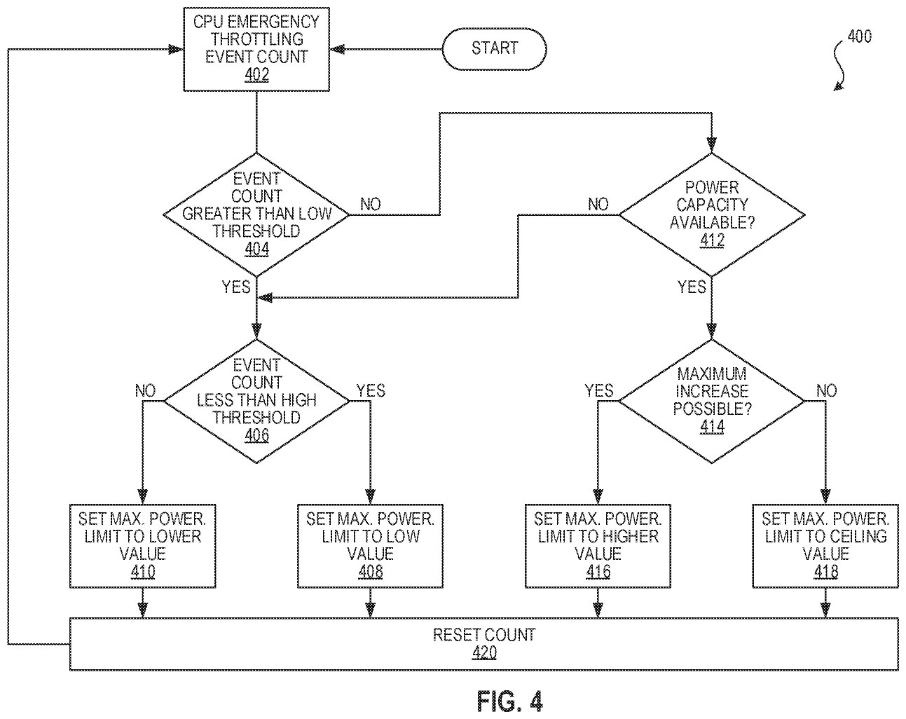

FIG. 4 shows an example method 400 of setting a maximum power limit of a CPU based on emergency throttling events of the CPU, as constrained by computing device power supply and usage. The method 400 may be implemented as instructions that may be executed by a controller or similar device, as discussed elsewhere herein.

At block 402, a count of emergency throttling events is obtained. A running total of emergency throttling events may be maintained, and block 402 may look up that value. The count may be increased by another process in response to detection of an emergency throttling event. Such a process may be executed atomically to prevent a race condition with the method 400.

At block 404, the count of emergency throttling events is compared to a low threshold which is the threshold that initially determines whether the maximum power limit of the CPU should be decreased or whether it may be increased. An example threshold is zero, meaning any emergency throttling event disallows an increase to the maximum power limit of the CPU.

If the count of emergency throttling events exceeds the low threshold, then the maximum power limit of the CPU will not be increased and, instead, may be decreased, Block 406 compares the count of emergency throttling events to a high threshold that distinguishes between degrees of decrease to the maximum power limit. The high threshold is selected with the recognition that the maximum power limit should be lowered and with the aim of determining by how much.

If the count of emergency throttling events is less than the high threshold, at block 406, then the maximum power limit is set to a low value, at block 408. That is, the emergency throttling events merely call for a gentle decrease to the maximum power limit. The low value may be computed as:

min(MPL*F1, (CPM_HLIM-ROP)*F)

where min is a function that returns the minimum of the provided arguments,

MPL is the current maximum power level,

F1 is a factor to allow for a safety margin, which may be selected or tuned for specific implementations, and

(CPM_HLIM-ROP)*F is, as discussed above, the maximum allowed instantaneous power of the power supply reduced by power consumed by other components of the computing device, reduced by a factor for safety margin.

In this example, F and F1 may both be 0.95, meaning that maximum power limit is reduced to 95% of its current value or to 95% of the power available to the CPU, whichever is lower.

If the count of emergency throttling events is not less than the high threshold, at block 410, then the maximum power limit is set to a lower value, in recognition that quicker adjustment to the maximum power limit is required. The lower value may be computed as:

min(MPL*F2, (CPM_HLIM−ROP)*F)

where F2 is a factor to allow for a safety margin, which may be selected or tuned for specific implementations, and the other variables are as discussed above.

In this example, F2 is set to 0.85 and F is set to 0.90, meaning that maximum power limit is reduced to 85% of its current value or to 90% of the power available to the CPU, whichever is lower. In either case, this reduction has a greater magnitude than that of block 408.

Blocks 406-410 may be considered to reduce the maximum power limit to a level that is inversely proportional to the amount of emergency throttling. A high amount of emergency throttling results in a greatly reduced level (block 410), whereas a lower amount of emergency throttling results in a somewhat reduced level (block 408).

At block 404, if the count of emergency throttling events does not exceed the low threshold, then the maximum power limit of the CPU may be increased. Block 412 determines whether the computing device has power capacity to allow an increase to the maximum power limit of the CPU. For example, it the total of the current maximum power limit and the power used by the other components of the computing device is less than the maximum allowed instantaneous power of the computing device's power supply, then an increase to the maximum power limit may be allowed. The following inequation may be tested:

MPL+HOP<CPM_HLIM

If the result of this test is true, then the maximum power limit may be increased. If not, then a decrease should be considered instead, at block 406.

If the maximum power limit is to be increased, then the degree of acceptable increase may be evaluated, at block 414. The manufacturer of the CPU may dictate a ceiling for the maximum power limit which the setting of the maximum power limit is not to exceed. The following inequation may be tested:

CPM_HLIM-ROP<CEILING

where CEILING is the highest allowable setting for the maximum power limit.

If the result of this test is true, then there is room to freely raise the maximum power limit, at block 416. If the result of this test is false, then the maximum power limit may instead be set to ceiling value dictated by the CPU manufacturer, at block 418.

At block 416, the maximum power limit may be set as follows:

(CPM_HLIM-ROP)*F

where F may be selected as 0.95. As such, the maximum power limit may be raised to 95% of the available power.

Blocks 412-418 may be considered to increase the maximum power limit to a level that is inversely proportional the additional power usage of the other components of the computing device. A low amount of power usage by other components results in a greatly increased level (block 416), whereas a higher amount of power usage by other components results in a somewhat increased level (also block 416), where any increase is limited by the ceiling level for the CPU (block 418).

Setting the maximum power limit at blocks 408, 410, 416, 418 may first check whether the new value to be set is different from the current value. Redundantly setting the maximum power limit to the same value may be avoided.

After the maximum power limit is set at block 408, 410, 416, or 418, the count of emergency throttling events may be reset to zero, at block 420.

The method 400 may be repeated regularly, such as at a period selected from a range of about 50 ms to about 500 ms, for example 200 ms. Such regular repetition may define a recency interval for testing the severity of emergency throttling. The values of the factors, F, F1, and F2, and the values of the low and high threshold counts may be selected with regard to the recency interval, so as to dynamically set the maximum power limit to increase performance when possible.

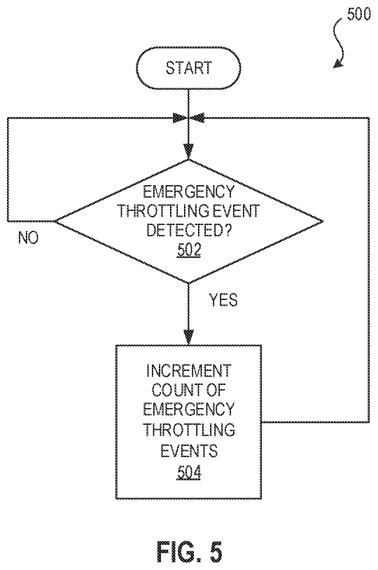

FIG. 5 shows an example method 500 to count emergency throttling events of a CPU. The method 500 may be implemented as instructions that may be executed by a controller or similar device, as discussed elsewhere herein. The method 500 may be performed in parallel with a method, such as method 200 or 400, for using such a count to determine whether to increase or decrease the CPU's maximum power level.

If an emergency throttling event is detected, such as by detecting a PROCHOT# assertion, at block 502, then a count emergency throttling events is incremented. A running total of emergency throttling events may thus be maintained until it is reset. The method 500 may be performed continuously and atomically to prevent a race condition.

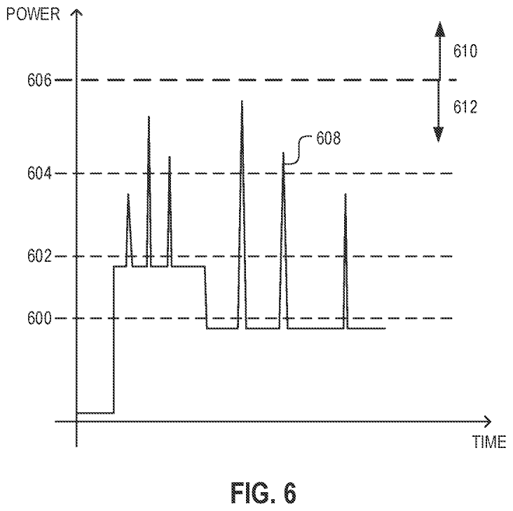

FIG. 6 shows an example power vs. time graph of a CPU with an example of setting of a maximum power limit of a CPU based on emergency throttling events of the CPU.

A CPU may have multiple power limits 600-606, including a maximum power limit 606 that the CPU is controlled to never exceed by way of an internal frequency control algorithm.

Other power limits may include an indefinitely sustainable power limit 600 (e.g., PL1), an intermediate power limit 602 (e.g., PL2) sustainable for a relatively long duration, such as 100 seconds, and a high power limit 604 (e.g., PL3) that is sustainable for a relatively short duration, such as 10 ms, to account for short peaks and spikes.

Power spikes 608 may trigger emergency throttling at the CPU. The maximum power limit may be dynamically increased 610 and decreased 612 based on emergency throttling to increase throughput and decrease cycling of emergency throttling and the likelihood of side effects.

In view of the above, it should be apparent that the dynamic control of a CPU power limit may be effected based on an amount of emergency throttling at the CPU with regard to power used by other components of the computing device. A maximum power limit may be increased, so as to increase processing throughput, when recent emergency throttling is determined to be low or nil. When recent emergency throttling is determined to be high, a maximum power limit may be decreased, so as to avoid cycling of an emergency throttling state and reduce or eliminate side effects, such as vibration and capacitor hum.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a controller, cause the controller to:
detect an emergency throttling event of a central processing unit (CPU) of a computing device; and
if the CPU has undergone fewer than a threshold number of emergency throttling events, increase a current maximum power limit of the CPU to an increased maximum power limit.

2. The non-transitory machine-readable medium of claim 1, wherein the instructions are to count the emergency throttling events during a recency interval and compare the count to the threshold number.

3. The non-transitory machine-readable medium of claim 2, wherein the instructions are further to decrease the current maximum power limit of the CPU to a decreased maximum power limit if the CPU has undergone more than the threshold number of emergency throttling events within the recency interval.

4. The non-transitory machine-readable medium of claim 3, wherein the instructions are to determine the decreased maximum power limit based on the count of emergency throttling events occurring within the recency interval.

5. The non-transitory machine-readable medium of claim 1, wherein the instructions are further to constrain the increased maximum power limit to a maximum allowed instantaneous power of the computing device as reduced by power usage of a component of the computing device other than the CPU.

6. A computing device comprising:
a processor operable according to a maximum power limit; and
a controller in communication with the processor, the controller to perform monitoring of emergency throttling at the processor and set the maximum power limit of the processor according to the monitoring of the emergency throttling.

7. The computing device of claim 6, wherein the controller is to increase the maximum power limit of the processor in response to a low amount of recent emergency throttling.

8. The computing device of claim 7, wherein the controller is further to:
determine additional power usage of a component of the computing device other than the processor; and
constrain the maximum power limit of the processor and the additional power usage to not exceed a maximum allowed instantaneous power of the computing device.

9. The computing device of claim 7, wherein the controller is further to:
determine additional power usage of a component of the computing device other than the processor; and
increase the maximum power limit of the processor to a level that is inversely proportional to the additional power usage.

10. The computing device of claim 6, wherein the controller is to decrease the maximum power limit of the processor in response to a high amount of recent emergency throttling.

11. The computing device of claim 10, wherein the controller is further to decrease the maximum power limit of the processor to a level that is inversely proportional to the high amount of recent emergency throttling.

12. A method comprising:
monitoring emergency throttling of a central processing unit (CPU); and
setting a power limit of the CPU as inversely proportional to an amount of the emergency throttling of the CPU.

13. The method of claim 12, wherein setting the power limit of the CPU includes increasing the power limit when recent emergency throttling is less than or equal to a threshold amount.

14. The method of claim 12, wherein setting the power limit of the CPU includes decreasing the power limit when recent emergency throttling is greater than a threshold amount.

15. The method of claim 12, wherein the power limit is a maximum power limit enforced by the CPU.
